(19) United States
(12) Patent Application Publication
(10) Pub. No.: US 2014/0258412 A1
(43) Pub. Date: Sep. 11, 2014

(54) METHOD AND APPARATUS FOR SERVICE MIGRATION BETWEEN USER DEVICES

(71) Applicant: Huawei Technologies Co., LTD., Shenzhen (CN)

(72) Inventors: Bojie Li, Shenzhen (CN); Wei Zhang, Shenzhen (CN); Chenghui Peng, Shenzhen (CN); Songwu Lu, Shenzhen (CN); Chiyu Li, Shenzhen (CN)

(21) Appl. No.: 14/285,012

(22) Filed: May 22, 2014

Related U.S. Application Data
(63) Continuation of application No. PCT/CN2012/084928, filed on Nov. 21, 2012.

(30) Foreign Application Priority Data
Nov. 22, 2011 (CN) 201110374415.1

(51) Int. Cl. H04L 29/08

(52) U.S. Cl. CPC H04L 67/10
USPC 709/204

(57) ABSTRACT

A method for service migration between user devices includes: receiving a migration from request MFR transmitted by a service migration protocol application SMPA entity of a first device; transmitting a service migration protocol SMP resolution request SRR to a service migration protocol server SMPS entity; receiving a response message transmitted by the SMPS entity; transmitting a migration to request MTR to an SMPA entity of the second device; transmitting a service acquired from the service source device to the second device, after the second device initiates the service application and switches the first SID to the second SID, so as to migrate the service of the first device to the second device. The present invention enables each user to perform seamless migration between different devices of the user in different situations without interrupting the service reception, or even receive the service with a preference device of the user.

### CROSS-REFERENCE TO RELATED APPLICATIONS

This application is a continuation of International Application No. PCT/CN2012/084928, filed on Nov. 21, 2012, which claims priority to Chinese Patent Application No. 201110374415.1, filed with Chinese Patent Office, on Nov. 22, 2011, entitled “Method and Apparatus for Service Migration between User Devices”, both of which are incorporated herein by reference in their entireties.

### TECHNICAL FIELD

Embodiments of the present invention relate to the field of communication, and more particularly to a method and an apparatus for service migration between user devices.

### BACKGROUND

In recent years, it has become very common that a user possesses multiple devices with network capability. For example, a user has one computer at the office, one computer at home, and meanwhile also has a portable iPhone or iPad. Such a single-user multi-device scenario brings new opportunities and challenges to a network protocol design and an operator.

In an existing method and system for service migration, initially, a first device and a second device have a video stream service carried on a real-time transport protocol (Real-time Transport Protocol, RTP), intermediate proxies of the two devices are a first intermediate proxy and a second intermediate proxy respectively. Then, it is assumed that the first device initiates a request to a media migration controller, so as to migrate the video stream service to a third device. The media migration controller will simultaneously negotiate service migration issues with the third device and the first intermediate proxy, after the negotiation is completed, the first intermediate proxy will forward data packets of the service to the third device. However, the method and the system for service migration fails to give a signaling procedure of the terminal during the service migration, and thus the existing application and protocol must be modified, and still fails to indicate how to achieve seamless migration and how to process transient loss of a media intermediate proxy and avoid data loss. Moreover, the method and the system for service migration still fails to support namespace management, namely, failing to support a user-specific service which is a service to guarantee that contents are transmitted to the most suitable devices of the user; moreover, failing to support easy management of the user to the multiple devices, or provide various communication modes, such as unicast, anycast and multicast.

Moreover, in the existing method for video service migration between a stationary media device and a mobile media device, a migration originating end and a migration destination end, which are located in different networks and based on a specific communication protocol, are included, and the service to be migrated is supposed to be a video service. The migration process includes: variables for the video service are defined to play the video contents on the device; the video variables are transmitted from a network where the migration originating end is located to a network where the migration destination end is located, and at least one server is passed through in the transmission process to perform protocol conversion between the two networks. In this method, it is also necessary to modify the existing media server platform, so as to support signaling processing in the migration process, and also modify the existing application to support service state migration. Moreover, because the service migration is performed by transmitting video variables between devices in this method, not taking any seamless operation into consideration, so there is no way to support seamless migration. This method still does not support the namespace management system, that is, not support the user-specific service.

### SUMMARY

Embodiments of the present invention provide a method and an apparatus for service migration between user devices, capable of implementing service migration between different devices of a user without modifying an existing protocol stack and application, and the service application of a terminal and a service source does not necessarily require any modification, and the service source is not aware of switching the terminal by the user.

On one aspect, a method for service migration between user devices is provided, including: receiving a migration from request MFR transmitted by a service migration protocol application SMPA entity of a first device, where the MFR carries a device identity DID of a second device and a first service identity SID, and is used for requesting to migrate a service of the first device to the second device, where the first service identity SID indicates a service stream between the first device and a service source device, and the first device and the second device belong to a first user; after knowing the DID of the second device from the MFR, transmitting a service migration protocol SMP resolution request SRR to a service migration protocol server SMPS entity, where the SRR carries the device identity DID of the second device; receiving a response message transmitted by the SMPS entity, where the response message carries a care-of address CoA of the second device resolved according to the device identity DID of the second device carried by the SRR; transmitting a migration to request MTR to an SMPA entity of the second device according to the care-of address CoA of the second device, so that the second device initiate a service application and switch the first SID to the second SID, where the MTR carries the first service identity SID; and after the second device initiates the service application and switches the first SID to the second SID, transmitting a service acquired from the service source device to the second device, so as to migrate the service of the first device to the second device, where the second SID indicates a service stream between the second device and the service source device.

On another aspect, an apparatus for service migration between user devices is provided, including a transmission unit and an acquisition unit; the transmission unit is configured to receive a migration from request MFR transmitted by a service migration protocol application SMPA entity of a first device, where the MFR carries a device identity DID of a second device and a first service identity SID, and is used for requesting to migrate a service of a first device to a second device, where the first service identity SID indicates a service stream between the first device and a service source device, and the first device and the second device belong to a first user; transmit a service migration protocol SMP resolution request SRR to a service migration protocol server SMPS entity, after knowing the DID of the second device from the MFR, where the SRR carries the device identity DID of the second device; receive a response message transmitted by the SMPS entity, wherein the response message carries a care-of address CoA of the second device resolved according to the device identity DID of the second device carried by the SRR; transmit a migration to request MTR to an SMPA entity of the second device according to the care-of address CoA of the second device, so that the second device initiates a service application and switches the first SID to the second SID, where the MTR carries the first service identity SID; where the care-of address CoA of the second device is a care-of address inquired and resolved by the SMPS entity from a global namespace and corresponding to the DID of the second device carried in the SRR. The acquisition unit is configured to, after the second device initiates the service application and switches the first SID to the second SID, acquire a service on the service source device, and transmit the service acquired from the service source device to the second device, so as to migrate the service of the first device to the second device, where the second SID indicates a service stream between the second device and the service source device.

In embodiments of the present invention, each user can perform seamless migration between different devices of the user in different situations without interrupting the service reception, or even use a device the user preferred to receive the service. In addition, the embodiments of the present invention can complete service migration without making any modification to the existing protocol and application.

### BRIEF DESCRIPTION OF DRAWINGS

To illustrate the technical solutions in embodiments of the present invention more clearly, accompanying drawings needed in the embodiments or the prior art are illustrated briefly in the following. Apparently, the accompanying drawings show certain embodiments of the present invention, and persons skilled in the art can derive other drawings from them without creative efforts.

FIG. 1 shows an example of a personal namespace.

FIG. 2 shows an example of a namespace group.

FIG. 3 shows an example of a global namespace.

FIG. 4 is a schematic structural diagram of an SMP system according to an embodiment of the present invention.

FIG. 5 shows an example of an address book.

FIG. 6 is a flow chart of a method for service migration between user devices according to an embodiment of the present invention.

FIG. 7 is a flow chart of a method for service migration between user devices according to another embodiment of the present invention.

FIG. 8 is a schematic diagram showing a process of acquiring services according to an embodiment of the present invention.

FIG. 9 is a schematic diagram showing a process of sharing services according to an embodiment of the present invention.

FIG. 10 is a schematic diagram showing a process of migrating services according to an embodiment of the present invention.

FIG. 11 is a schematic diagram showing a process of migrating services according to an embodiment of the present invention.

FIG. 12 is a schematic structural diagram of an apparatus for service migration between user devices according to an embodiment of the present invention.

FIG. 13 is a schematic structural diagram of an apparatus for service migration between user devices according to another embodiment of the present invention.

### DESCRIPTION OF EMBODIMENTS

The technical solutions in the embodiments of the present invention are hereinafter described clearly and completely with reference to the accompanying drawings in the embodiments of the present invention. Obviously, the embodiments described here are part of the embodiments of the invention and not all of the embodiments. All other embodiments obtained by persons skilled in the art on the basis of the embodiments of the present invention without any creative efforts all fall within the protection scope of the invention.

The method and the apparatus for service migration between user devices provided in the present invention can support a new data communication mode, so as to adapt to communication between multiple devices of the same user, so that data can be migrated seamlessly between multiple devices of the same user, or transmitted simultaneously to these devices in a multicast mode. For example, a user possessing a plurality of devices may receive video segments shared by his friends, and he can directly receive them with his office computer when he is at the office, and can continue to view these ongoing video services with his iPhone or iPad when he is out for lunch. Moreover, only minor modifications need to be made to the existing network while the user performs single-user multi-device data communication, so that the Internet (Internet) application presented in the existing network can be reused.

Furthermore, the method and the apparatus for service migration between user devices according to the present invention also can transmit service contents to the most suitable devices of a user, and meanwhile the user can manage these devices. Particularly, the service can be transferred with a user datagram protocol (User Datagram Protocol, UDP) or a transmission control protocol (Transmission Control Protocol, TCP), and support unicast, multicast and anycast. In a case of anycast, the service is transmitted to a proximate or optimum device of the user.

Currently, there have been many protocols for service migration between multiple devices of a single user, which mainly includes data service migration, service state migration and socket (socket) migration. In addition, a naming mechanism for supporting mobility between devices needs to be adopted, so as to support the user-specific service.

The present invention adopts a naming solution based on an identity/address (Identity/Internet Protocol, ID/IP) separation mechanism, and the ID/IP separation mechanism can help to solve the problem of mobility. For different purposes, most of the existing naming solutions separately name the users, devices and services, and some solutions also hybridly name the users and devices. The naming solution of the present invention differs from the existing naming solution mainly in two points: first, most of the existing naming solutions need to modify an existing network protocol or change a network infrastructure, while the naming solution of the present invention doesn't need to modify the existing protocol and a network architecture; second, the existing naming solution is not directed to a single-user multi-device scenario, and thus cannot be directly used to solve problems of the present invention.

How to support the user-specific service and the data seamless migration by the present invention without changing the existing network protocol will be described in more detail further below.

In order to support the user-specific service, the method and the system for service migration between user devices provided in the present invention need to possess a namespace management capability. The present invention adopts a namespace management solution, which has the ID/IP separation mechanism and can be applied to a service migration protocol (Service Migration Protocol, SMP) system in a single-user multi-device scenario, so that the user can manage his devices and contact devices of his friends through the namespace management solution, and help the user to find and address the most appropriate devices of his friends.

The SMP namespace is divided into three levels: name, identity and address, which can be associated with each other through two-dimensional mapping, one dimension is mapping from name to identity, then to address, while another dimension is mapping from user identity (User Identity, UID) to device identity (Device Identity, DID).

Generally speaking, name is human-readable and classified into a user name (User name, UN) and a device name (Device name, DN), which are used to identify the user and the device respectively, for example, the former is Bob, and the latter is Laptop. The identity is to identify the user and the device in the SMP system respectively with the user identity UID and the device identity DID, which are all globally unique and unchangeable. In general, the UID is of an email address format, such as bob@ucla.edu, the DID is formed by binding a device name on the basis of the UID, such as laptop.bob@ucla.edu, and the DID is initially designated by the user of the device. The address is an IP address, but the IP address only has an address function in the SMP system, and its identity function has been replaced by the DID, which is different from the IP in the existing system that has both the identity function and the address function.

The three levels of name/identity/address are managed through the two-dimensional mapping. Specifically, mapping of one dimension is to respectively map each UN and each DN to a globally unique UID and DID, and each DID is mapped to a care-of address (care-of address, CoA). Mapping of another dimension can map each UID to one or more DIDs, because each user can possess one or more devices.

Therefore, the SMP system defines three types of namespace structures according to the above SMP namespace, namely a personal namespace, a namespace group and a global namespace.

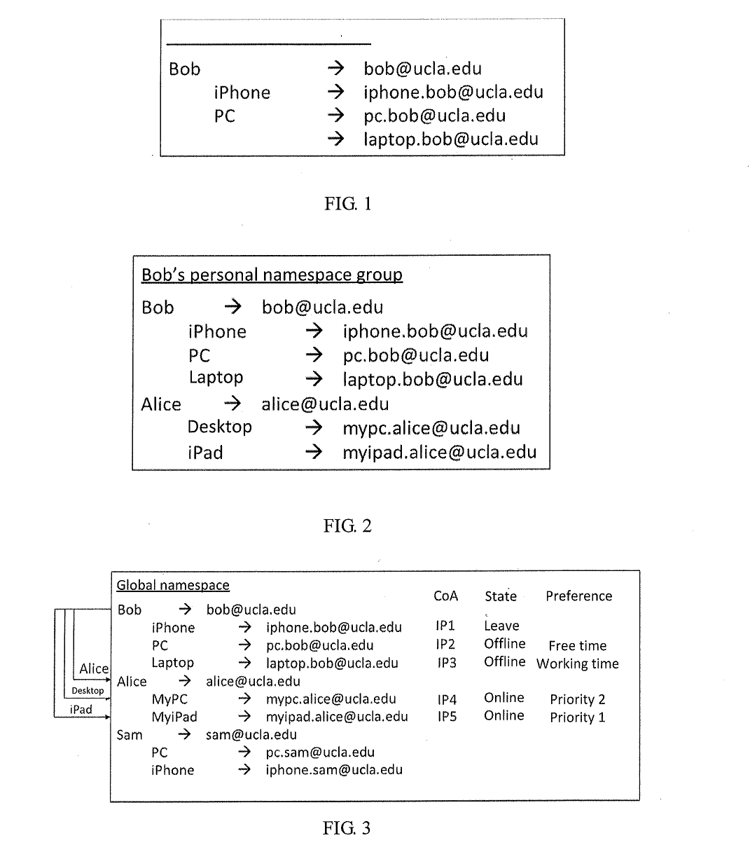

As for the personal namespace, each user possesses one personal namespace, including personal UN, UID, as well as DN and DID of the possessed devices. As shown in FIG. 1, in Bob's personal namespace, Bob is UN, bob@ucla.edu is Bob's UID, left bottom column is DN of Bob's possessed device, and right is corresponding DID.

As for the namespace group, each user has one namespace group, including user's personal namespace and his friend's personal namespace, as shown in FIG. 2, Bob's namespace group includes Bob's personal namespace and his friend Alice's personal namespace. Both UN and DN in the namespace group can be designated by the user, but should be unique in the same namespace group, for example, Alice's iPad has a DN named Myipad in her namespace group, but a DN named iPad in Bob's namespace group.

As for the global namespace, an SMP server (Service Migration Protocol Server, SMPS) maintains one global namespace, including namespace group of each user, and information such as CoA, state and preference of user's each device, as shown in FIG. 3. The friend's personal namespace in the user's namespace group is directly pointed to the personal namespace of user's friend by way of reference or link. The CoA information is current CoA address of the device, the state information indicates current information of the user, such as online, offline, leave, and the preference information indicates information such as which device is a preferential communication object or communication time period of the device. The global namespace does not necessarily need to include UN and DN, and may further include a time stamp when user's namespace group is updated.

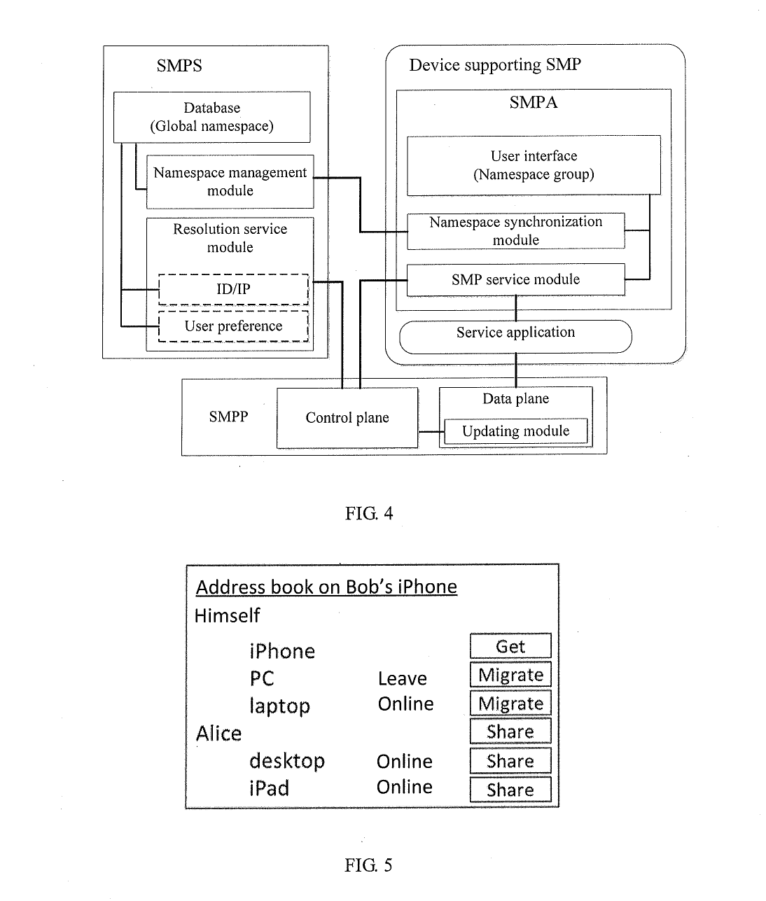

According to embodiments of the present invention, the SMP system includes three main entities: SMP server (SMP Server) SMPS, SMP proxy (SMP Proxy) SMPP, and SMP application (SMP Application) SMPA, as shown in FIG. 4.

Particularly, the SMPS entity is mainly responsible for management of the global namespace and name resolution service. The SMPA entity is installed on the user device, and mainly includes a namespace synchronization module and an SMP service module. The SMPP entity is located between a service source and a service receiver, for processing service data relay and service migration.

Hereinafter, functions and structures of the SMPS entity, SMPA entity and SMPP entity will be described in details with reference to FIG. 4.

As shown in FIG. 4, the SMPS entity maintains one global namespace and two major modules: a namespace management module and a resolution service module. The namespace management module of the SMPS entity manages user registration and namespace synchronization, and the two functions will be described later. The former is to construct a namespace group of a user, and the latter is to maintain synchronization between the global namespace and the namespace group on the user device. The SMPS entity also provides a resolution service based on a global namespace database, namely a function of the resolution service module. The resolution includes resolution from an identity to an address and resolution of user preference, the former resolves an address of a device, and the latter resolves a preference device of the user. When receiving a resolution request carrying a DID, the SMPS entity inquires global namespace data to obtain a CoA corresponding to the DID, and returns the CoA to a transmitter of the resolution request. When receiving a resolution request carrying a UID, database is firstly inquired to obtain DID of user's preference device, then obtains the CoA according to the DID, and finally returns the obtained DID and CoA to the transmitter of the resolution request.

Referring to an SMPA entity shown in FIG. 4, the SMPA entity is installed on a terminal device supporting SMP, and provides a user with an interface including an address book and an SMP service. In addition, the SMPA entity further includes two major modules: a namespace synchronization module and an SMP service module. As shown in FIG. 5, an address book is based on a user's namespace group, and the namespace group is maintained by the namespace synchronization module, and the module can collaborate with the namespace management module of the SMPS entity by using the namespace state synchronization function. The SMP service module mainly provides three types of services: service acquisition, service sharing and service migration. The service acquisition is to acquire a service required by a user's device from a service source device, the service sharing is to share a service on a device of the user with a device of user's friend, and the service migration is to migrate a service on a device of the user to another device.

Specifically, in terms of acquiring a service, it is assumed that the SMP service presents a video service on a local device currently used by a user, and the service acquisition can be triggered by clicking a “Get” button on an interface of an SMPA entity, as shown in FIG. 5. After clicking the “Get” button, the user also needs to provide a uniform resource locator (Uniform Resource Locator, URL) of a desired video, an SMP service module combines the URL and DID of the local device to form a service ID (Service ID, SID), and uses the SID to trigger a local video application by means of a command tool. The local video application uses the SID to acquire the video service through a proxy, for example, the local video application needs to set its proxy as an address of the SMPP entity.

Specifically, in terms of sharing a service, it is assumed that the SMP service enables the user to share a video service with a device of user's friend, and the service sharing can be triggered by clicking a “Share” button on the interface of the SMPA entity, as shown in FIG. 5. If Bob selects the “Share” button corresponding to user Alice, and then shares a video to a certain device of Alice in anycast mode; if Bob selects the “Share” button corresponding to a certain device of Alice, and then shares the video to the designated device of Alice in unicast mode, and of course, these devices must be online. After clicking the “Share” button, the user also needs to provide a URL of the shared video, and then the SMPA entity transmits a request including the URL, the DID of the local device, UID or DID of a shared target to the SMPP entity to initiate a sharing process.

Specifically, in terms of migrating a service, it is assumed that the SMP service enables the user to migrate an ongoing video service from the current device to another device, and the service migration can be triggered by clicking a “Migrate” button on the interface of the SMPA entity, as shown in FIG. 5. After clicking the “Migrate” button, the user also needs to select a URL of a migrated video (the SMPA entity saves the URL of the video when the video is playing), and then the SMPA entity transmits a request including the URL, the DID of the local device, DID of a migrated target device to the SMPP entity to initiate a migration process.

As shown in FIG. 4, the SMPP entity includes a control plane and a data plane, particularly, the control plane collaborates with the SMPS entity and the SMPA entity, to process signaling in the service acquisition, sharing and migration, and the data plane is responsible for forwarding data packets at both communication ends and shielding migration operations of the opposite communication end, so that both ends can operate normally during the service migration, and service interruption can be prevented during the service migration.

Specifically, the signaling for processing service sharing also coordinates service migration. When the SMPP entity receives a sharing request or a migrating request, the SMPP entity uses the resolution service module of the SMPS entity to resolve an address of a device corresponding to target UID or DID included in the request. Then, in terms of service sharing, the SMPP entity transmits a notification of service sharing to the SMP service module in the SMPA entity of the target device according to the address obtained through resolution, and the notification carries DID of a service sharing initiator and URL of the shared service. In terms of service migration, the SMPP entity transmits a notification of service migration carrying URL of the migrated service, to the SMP service module in the SMPA entity of the target device, so that the device can be ready to receive the service, and meanwhile the SMPP entity can switch to the target device through controlling service data of the data plane by the updating module.

Specifically, the SMPP entity bridges both ends of the service, and thereby relays and transmits service data from one end to another according to a forwarding table. Table 1 below is an example of the forwarding table in the SMPP entity, and each entry includes SID, a target device DID, and IP addresses and ports of a server, a client and the SMPP entity. Generally, each video service will create one or more entries on the forwarding table when established. For example, during the video service migration, the updating module of the SMPP entity is responsible for updating forwarding table entries of corresponding service, and then the SMPP entity forwards video data according to the new forwarding address. One video service may include multiple services, for example, when being carried with RTP/UDP (Real-time Transport Protocol/User Datagram Protocol, real-time transport protocol/user datagram protocol), video stream and audio stream are separate RTP services, and each RTP service further includes two forwarding table entries of RTP and RTCP (RTP Control Protocol, RTP control protocol).

As shown in Table 1, taking a video service transmitted by Alice's desktop to Bob's iPhone as an example, four entries are listed in the forwarding table, and all these entries are associated with the same SID and DID. SID is formed by combining URL of Alice's video and DID of Bob's iPhone, a server address is the address of Alice's desktop, an SMPP entity address is typically a group of address pool, which can be designed to use different addresses for a server and a client, a client address is the address of Bob's iPhone, and a port can be determined by a service negotiation, such as through an SDP (session description protocol, session description protocol) protocol of the RTSP. During the service negotiation, the SMPP entity can respectively replace an IP address and a port of the server and the client with its own egress address/port and ingress address/port, thereby the video service can be firstly transmitted from Alice's desktop to the ingress address of the SMPP entity, and then transmitted to Bob's iPhone with the egress address of the SMPP entity.

TABLE 1
Forwarding Table in the SMPP Entity
Forwarding table in SMPP

| | | Server | | SMPP (Server) | |
|---|---|---|---|---|---|
| SID | DID | IP | Port | IP | Port |
| http://131.179.201.222/video1:iphone.bob@ucla.edu | iphone.bob@ucla.edu | 131.179.201.222 | 555 | 140.113.167.151 | 486 |
| http://131.179.201.222/video1:iphone.bob@ucla.edu | iphone.bob@ucla.edu | 131.179.201.222 | 555 | 140.113.167.151 | 487 |
| http://131.179.201.222/video1:iphone.bob@ucla.edu | iphone.bob@ucla.edu | 131.179.201.222 | 555 | 140.113.167.151 | 556 |
| http://131.179.201.222/video1:iphone.bob@ucla.edu | iphone.bob@ucla.edu | 131.179.201.222 | 555 | 140.113.167.151 | 557 |
| | | SMPP (Client) | | Client | |
| SID | DID | IP | Port | IP | Port |
| http://131.179.201.222/video1:iphone.bob@ucla.edu | iphone.bob@ucla.edu | 140.113.167.188 | 666 | 131.188.225.232 | 332 |
| http://131.179.201.222/video1:iphone.bob@ucla.edu | iphone.bob@ucla.edu | 140.113.167.188 | 666 | 131.188.225.232 | 333 |
| http://131.179.201.222/video1:iphone.bob@ucla.edu | iphone.bob@ucla.edu | 140.113.167.188 | 666 | 131.188.225.232 | 358 |
| http://131.179.201.222/video1:iphone.bob@ucla.edu | iphone.bob@ucla.edu | 140.113.167.188 | 666 | 131.188.225.232 | 359 |

In addition to the unicast and anycast modes described above, the SMPP entity also supports a multicast mode. As in the example above, if Alice's video service needs to be simultaneously transmitted to Bob's iPhone and laptop, then four forwarding table entries needs to be further added on the basis of the above four forwarding table entries. These newly added entries use the same SID, but different target DIDs (such as laptop.bob@ucla.edu), and the client IP address also needs to be replaced with a laptop address. When receiving a video service data packet from the server, the SMPP entity needs to additionally replicate the data so as to transmit to all receiving clients; when a reverse data packet is received, the SMPP entity only needs to relay and forward data packet of a primary client, which can be identified from the DID included in the SID, to the server, and drop data packets of other clients.

Understanding of the architecture of the SMP system can facilitate to understand how the SMP system to manage namespace and mobility.

Firstly, each user needs to register its personal namespace and namespace group to the SMPS entity, and meanwhile synchronize a state and an address of each device to the SMPS entity. Specifically, the user creates the namespace group including the personal namespace through the SMPA entity installed on the device, and registers the UID and DID of the device to the SMPS entity. When a new device is added in the personal namespace, DID of the new device also needs to be registered to the SMPS entity, or when a device is deleted, the SMPA entity also needs to notify the SMPS entity of deleting DID of a corresponding device. Therefore, in an SMPA entity, there is a need to detect uniqueness of UN, DN, UID and DID in the user's namespace group; while in an SMPS entity, there is a need to detect uniqueness of UID and DID in the global namespace. Once a conflict occurs, the SMPA entity or the SMPS entity requires the user to modify corresponding conflicting name or identity.

Further, in order to make the SMPS entity maintain the state of the user device, the SMPA entity of each online device needs to periodically transmit a heartbeat message carrying the DID of the device to the SMPS entity. The SMPS entity identifies the state of the device as online. If not receiving the heartbeat message of the device for a period of time, the SMPS entity identifies the state of the device as offline. The SMPS entity also can transmit the state of each device in the namespace group of the user to the user device, periodically or when state update occurs. However, in order to save signaling overhead, the heartbeat message also can carry a time stamp of the last update to the namespace group of the user. In this way, the SMPS entity only needs to compare time stamps before and after the state update to the namespace group of the user it maintains, if the two time stamps are consistent, the SMPS entity does not need to transmit the state information of the device to the user device.

In addition, the SMPA entity monitors a change of the IP address of the device. When the IP address of the device changes, the SMPA entity reports mapping relationship between the DID of the device and a new IP address to the SMPS entity. The SMPS entity then notifies the SMPP entity to modify the mapping between the DID and the IP address.

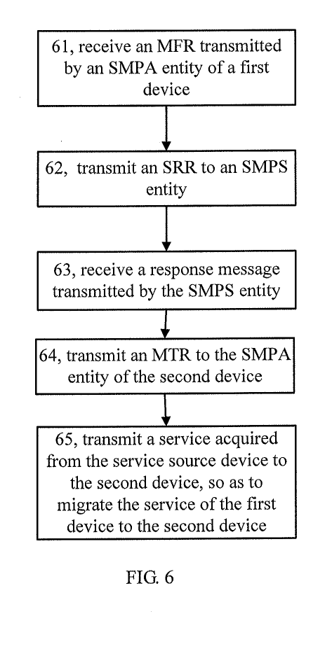

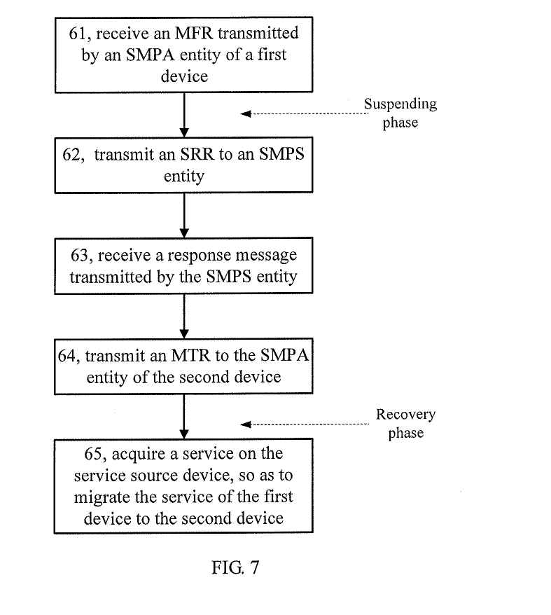

Hereinafter, a process for service migration between user devices according to an embodiment of the present invention will be described in detail with reference to FIG. 6.

61, An SMPP entity receives a migration from request (Migration From Request, MFR) transmitted by an SMPA entity of a first device, where the MFR carries a DID of a second device and a first service identity SID, and is used for requesting to migrate a service of a first device to a second device, and the first service identity SID indicates a service stream between the first device and a service source device, here, both the first device and the second device belong to a first user.

Optionally, the first service identity SID includes a service source URL and a DID of the first device.

As described above, the MFR is a control message transmitted by the SMP service module in the SMPA entity of the first device (i.e., service emigration device) to the SMPP entity, for requesting to migrate an ongoing service from one device to another device, i.e., requesting to migrate the service of the first device to the second device.

Generally speaking, service migration can be triggered by a user or a network. When the service migration is triggered by a user, the user can initiate the service migration by an input on an interface of the SMPA entity. When the user selects one service to be migrated, via the SMPA on the first device, and the second device (i.e., target device or service immigration device), the SMP service module of the SMPA entity of the first device transmits the MFR message to the SMPP entity to trigger the migration. When the service migration is triggered by a network, however, a data plane of the SMPP entity detects a session reception quality feedback (such as a report of the RTCP receiving end). When a certain condition is satisfied, switching is triggered, then the SMPP entity notifies, through the control plane, the first device of switching and the SMPA entity of the first device transmits a MFR to the SMPP entity to initiate switching.

62, Then, after knowing the DID of the second device from the MFR, the SMPP entity transmits an SMP resolution request (SMP Resolution Request, SRR) to an SMPS entity, where the SRR carries the DID of the second device.

Here, the SRR is a control message for requesting the resolution service module in the SMPS entity to resolve an address of a device or resolve a preference device of a user. Generally speaking, the SRR message can carry a UID or DID to be resolved.

As described above, when the SMPS entity receives the SRR transmitted by the SMPP entity, the resolution service module will inquire global namespace data in global namespace database to obtain a CoA corresponding to the DID, and returns the CoA to a transmitter of the resolution request. Optionally, when an SRR carrying a UID is received, the SMPS entity firstly inquires the database to obtain DID of user's preference device, then obtains the CoA according to the DID, and finally returns the obtained DID and CoA to the SMPP entity.

63, then, the SMPP entity receives a response message transmitted by the SMPS entity, where the response message carries a CoA of the second device resolved according to the device identity DID of the second device carried by the SRR.

That is to say, the SMPP entity acquires the care-of address CoA of the second device corresponding to the DID of the second device carried in the SRR, and the CoA of the second device is obtained by the SMPS entity through inquiring the global namespace and resolving. Throughout this specification, it has been described in detail that the global namespace defines the mapping between the user identity UID and the device identity DID, and the mapping between the device identity DID and the care-of address CoA. Therefore, a CoA of the second device having mapping relationship with the DID of the second device can be found by inquiring the global namespace, as long as the DID of the second device is known.

64, The SMPP entity transmits a migration to request (Migration To Request, MTR) to the SMPA entity of the second device according to the CoA of the second device, so that the second device initiates a service application and switches the first SID to the second SID, where the MTR carries the first service identity SID.

Here, the MTR is a control message transmitted by the SMPP entity to the SMP service module in the SMPA entity of the second device (i.e., service immigration device), for notifying the SMPA entity of the service immigration device of being ready to receive the migrated service.

65, After the second device initiates the service application and switches the first SID to the second SID, a service acquired from the service source device is transmitted to the second device, so as to migrate the service of the first device to the second device, where the second SID indicates a service stream between the second device and the service source device.

Optionally, the second SID includes a service source URL and a DID of the second device.

It can be seen from the above, the SMPP entity transmits an SRR to the SMPS according to the first SID and the DID of the second device carried in the MFR transmitted by the first device, obtains the CoA of the second device through resolution of the SMPS, and then transmits the MTR carrying the first SID required by the migration service to the SMPA entity of the second device. The SMP service module in the SMPA entity of the second device activates a service application of the second device, and connects it to the SMPP entity, where the SID used when activating the service application of the second device is a temporary SID formed by joining the first SID and the second device serially. Particularly, the first SID includes a service source URL and a DID of the first device. When a session starts, the SMPP entity resolves and buffers a context of the session. When a service migrates, the SMPP entity can modify a device address carried in the session context. Based on the temporary SID, a data plane of the SMPP entity updates migration information to the updating module, where the migration information includes a new SID formed by subtracting the DID of the first device from the temporary SID, and the DID and the address of the second device. Finally, the SMPP entity updates corresponding entries in the forwarding table through the updating module.

In view of the above, in the method for service migration between user devices in embodiments of the present invention, each user can perform seamless migration between different devices of the user in different situations without interrupting the service reception, or even receive the service with a preference device of the user. In addition, service migration can be completed without making any modification to the existing protocol and application in embodiments of the present invention.

The moment of the service migration will depend on the type of the service. Taking an MPEG4 encoded video service as an example, video contents may be decomposed into multiple groups of picture (Group of Picture, GOP), and each GOP can be separately decoded. Three types of frames, I-frames, P-frames and B-frames are usually contained in each GOP. Generally, the GOP firstly decodes I-frames, which does not need to be decoded depending on other frames; and then decodes P-frames and B-frames, because P-frames and B-frames can only be decoded depending on other frames. The optimal moment for migration is after ending of the last frame in the previous GOP and before starting of the next GOP, so as to prevent from affecting continuity of the service migration.

Generally speaking, the first device acquires the service from the service source device in an acquiring mode or a sharing mode, where the service source device can belong to the second user, or can be a server.

When the first device acquires the service from the service source device in the acquiring mode, the SMPP entity receives a service acquiring request, transmitted by the SMPA entity of the first device for requesting to acquire the service, and the service acquiring request carries the first SID. Then, the SMPP entity makes a request for acquiring the service to the service source device according to the service source URL of the first SID. Finally, the SMPP entity acquires the service from the service source device, for providing to the first device. Optionally, before making the request for acquiring the service to the service source device, the SMPP entity also needs to create a forwarding table entry, where the forwarding table entry includes the first SID and the DID and the address of the first device.

When the first device acquires the service from the service source device in the sharing mode, the SMPP entity receives a sharing request (Sharing Request, SR), transmitted by the SMPA entity of the service source device, where the SR is initiated by the SMP service module in the SMPA entity of the service source device, for sharing the service with other users, and therefore, the SR carries a DID of the service source device, a user identity UID of the first user or a DID of the first device, and a service source URL. If the service to be shared is a video service, then the SR will change to a video sharing request (Video Sharing Request, VSR). Then, the SMPP entity transmits an SRR to the SMPS entity, after knowing the user identity UID of the first user or the DID of the first device from the SR, where the SRR carries the UID of the first user or the DID of the first device. After receiving a response message, transmitted by the SMPS entity, where the response message carries a CoA of the first device resolved according to the UID of the first user or the DID of the first device carried by the SRR, the SMPP entity will also transmit the SR to the SMPA entity of the first device, so that the first device can initiate the service application. After the first device initiates the service application, the SMPP entity acquires the service on the service source device according to the DID of the service source device and the service source URL, for sharing to the first device.

That is to say, during the service sharing, when receiving the SR message, the control plane of the SMPP entity transmits the SRR message to the resolution service module in the SMPS entity for inquiring an address of a target device, and then forwards the SR message to the address. If the SR carries the DID of the target device, then an unicast device address is resolved; if the SR carries the UID of the target user, then an anycast device address or for a multicast device address list is resolved. For example, if the SR carries the DID of the first device, then the SMPP entity acquires the CoA of the first device resolved by the SMPS entity; if the SR carries the UID of the first user, then the SMPP entity acquires the CoA of the preference device of the first user or the CoAs of multiple devices of the first user, resolved by the SMPS entity. Assuming that the first device is a preference device of the first user, which is inquired and resolved by the SMPS entity from a global namespace and corresponding to the UID of the first user, when the first device receives the SR request, the SMP service module of the SMPA entity on the first device will trigger a local service application and connect to the SMPP entity, and the SID used when connecting to the SMPP entity includes a service source URL and a DID of the service source device. After receiving the service sharing request including the SID, the data plane of the SMPP entity resolves the URL included therein, and replaces the service application with the URL to request service data from the service source device.

The above acquired, shared and migrated services are all carried on the RTP/UDP protocol, while the service carried on the TCP protocol has different migration processes with the above services. Referring to FIG. 7, when the acquired, shared and migrated services are TCP services, the SMPP entity enters a suspending state after receiving the migration from request MFR transmitted by the SMPA entity of the first device, and then enters a recovery phase after the second device initiates the service application and switches the first SID to the second SID, and only at this time, the service of the first device is migrated to the second device. When the SMPP entity enters the suspending state, that is, the SMPP entity transmits acknowledgment (acknowledgement) message ACK to the service source device, where the ACK carries information indicating that a receiving window is 0, and buffers a packet with payload transmitted by the service source device, where a sequence number of the packet is after a sequence number acknowledged in the last acknowledgment message ACK transmitted by the first device before the service migration is completed. When the SMPP entity enters the recovery state, that is, after performing TCP handshake (such as, 3 times of handshake) with the second device the SMPP entity transmits the buffered packet to the second device; and when all the buffered packet has been transmitted, also transmits an ACK to the service source device, and at this time, the ACK carries information indicating that a receiving window is not 0.

Specifically, the SMPP entity initiates a migration process corresponding to a TCP connection after receiving an MFR request. The whole TCP connection between the service source device and the first device is divided into two sub-connections by the SMPP entity. The specific method is to suspend the TCP connection at first until the establishment of the link between the SMPP entity and the second device is completed; and then recover the TCP connection. Thus, the whole migration process is mainly divided into two phases: suspend and recovery. In the suspending phase, the main goal of the SMPP entity is to freeze the transmission process and buffer all the data packet not having been forwarded by the SMPP entity, and meanwhile keep a congestion threshold unchanged (achieved through preventing, by the service source device, unnecessary congestion control). In the above two-step operations, the purpose of “freezing the transmission process and buffering all the data packet not having been forwarded by the SMPP entity” is to avoid transitory data loss and keep a connection state, while the purpose of “keeping a congestion threshold unchanged” is to avoid service overload caused by mismatching of congestion windows of the sub-connections between the SMPP entity and the service source device or the first device after the migration. In the recovery phase, the SMPP entity will establish a new sub-connection with the second device, transmit the data packet previously buffered, and then recover the transmission process of the sub-connection between the SMPP entity and the service source device. After the link recovers, the sub-connection between the SMPP entity and the first device is terminated.

For example, in the suspending phase, once the SMPP entity receives the MFR message, then the SMPP entity enters the suspending phase until the service migration is completed. There are mainly three tasks in the suspending phase: first, notify the service source device that the receiving window is 0; second, stop forwarding the data packets to the first device and buffer all of them; third, return a zero window probe to the service source device. In a TCP flow control mechanism, the receiving end can prevent a transmitting end from transmitting data by notifying the transmitting end that the receiving window is 0, and the transmitting end only can continue to transmit data when a notification that the receiving window is greater than 0 is received. Therefore, embodiments of the present invention utilize such a feature of the TCP flow control mechanism, after the suspending phase starts, the SMPP entity will modify the receiving window in the acknowledgment message ACK transmitted by the first device to be 0, and forward the ACK to the service source device. Subsequently, the service source device will stop the transmission operation, and initiates a zero window detection operation, namely, periodic transmission of new data with at least one byte. Such operation aims at trying to recover operations and making sure of accurately detecting that the window has been recovered. During the migration, the SMPP entity needs to generate and transmit the ACK to return each detection segment, so as to give a next sequence number as desired and continue to declare the window is 0. With the above operations, it can be ensured that the TCP transmitting end of the service source device does not close the link but only freeze the transmission process, and thereby not causing the congestion threshold to jitter. In order to buffer those data packets not having been forwarded, when the suspending phase starts, the SMPP entity starts to buffer data packets from the service source device and stop forwarding them. Because these buffered data packets have been transmitted from the service source device, if the service source device has not received the acknowledgment message, the service source device will start a retransmission timer. Therefore, the SMPP entity can replace the migrated device (i.e., the second device) according to the situations, generate and transmit the ACK to the service source device. Such ACK also needs to include desired information, such as a sequence number and a window size. The SMPP entity needs to ensure that all the data packets within a range from the desired sequence number to the sequence number acknowledged in the last ACK transmitted by the first device before the migration have been buffered. There may be situations where the first device fails to acknowledge all the received data packets before the connection is off, and these data packets have not been buffered by the SMPP entity due to having been forwarded. A simplest solution is that, the SMPP entity transmits an ACK message to trigger a retransmission mechanism of the service source device, and buffers the data packets after the retransmission, but doing so will cause a threshold for a transmitting window of the service source device to reduce. In embodiments of the present invention, the influence caused by such conditions can be reduced by forcing the SMPP entity to buffer a certain amount of data packets in all the states (whether in a migration state or not). If packet loss still occurs, it is necessary to resolve through a retransmission mechanism. The buffer size can be configured to be a half of a transmission capacity of a round-trip time (Round-Trip Time, RTT) between the service source device and the first device.

For example, in the recovery phase, when the SMPA entity of the second device initiates a request for establishment of a new link, the recovery phase starts. The SMPP entity acts as a TCP end point and performs a process of handshake (such as, 3 times of handshake) with the second device, and transmits the buffered packets to the second device. As a TCP transmitter, the SMPP entity maintains some connection states, such as a congestion window and a congestion threshold and so on. When the transmission process initially starts or the link times out, a slow startup process is adopted at first, when the congestion window reaches the threshold, then an additive increase multiplicative decrease (Additive Increase Multiplicative Decrease, AIMD) algorithm is adopted. The SMPP entity does not forward the acknowledgment message ACK to the service source device. When all the buffered data packets have been acknowledged by the second device, the SMPP entity recovers the transmission process of the service source device by forwarding, to the service source device, the last ACK received by it transmitted by the second device. Then, the whole transmission process is recovered, because the last ACK indicates that the receiving window is no longer 0. Subsequently, the SMPP entity returns to a forwarding phase. It should be noted that, the initial sequence number randomly selected by the second device may cause different sequence number systems between the old and new links. Therefore, the SMPP entity needs to add sequence number mapping information to the forwarding table entries corresponding to the links, and modify its sequence numbers before forwarding each data packet.

In view of the above, when the method for service migration between user devices in embodiments of the present invention is applied in the TCP service, each user can perform seamless migration between different devices of the user in different situations without interrupting the service reception, or even receive the service with a preference device of the user. In addition, the embodiments of the present invention can complete service migration without making any modification to the existing protocol and application in.

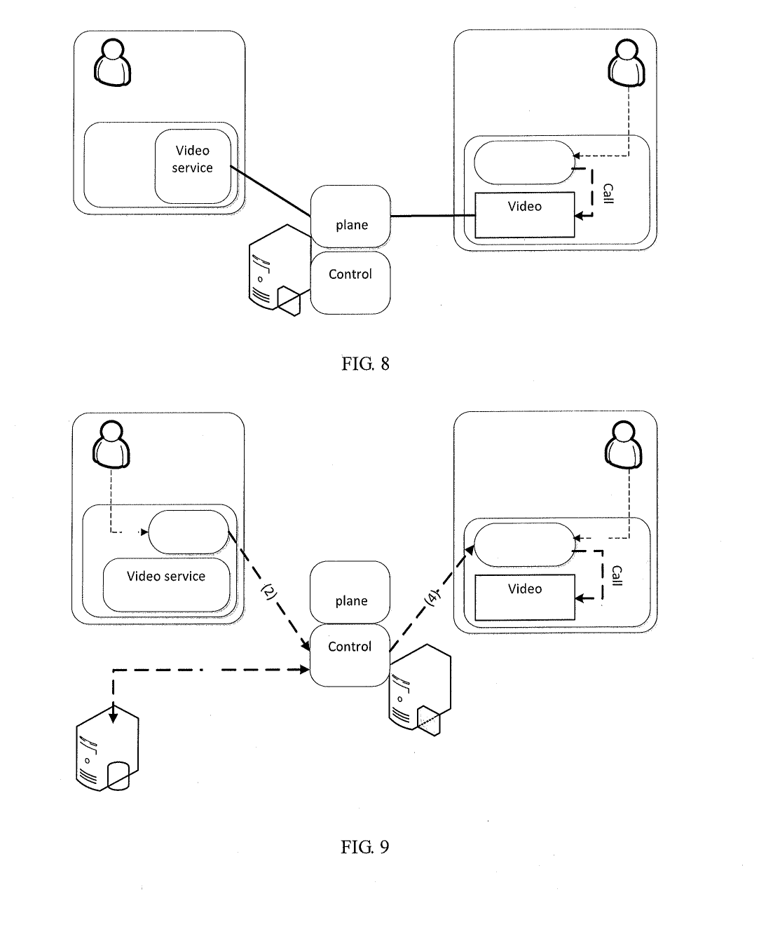

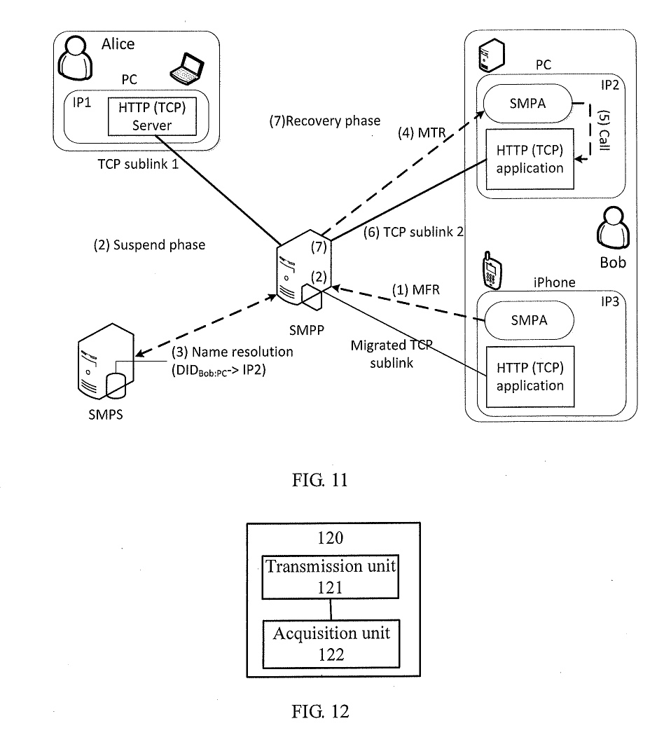

For convenience of description, how to migrate video services carried on the RTP/UDP protocol between two different devices of the same user will be illustratively described with reference to FIG. 8 to FIG. 10, and how to migrate video services carried on the TCP protocol between two different devices of the same user will be illustratively described with reference to FIG. 11. Meanwhile, for convenience of understanding, how to acquire a video service from a friend's device and how to acquire the video service shared from a friend's device will be introduced at first.

FIG. 8 shows an acquisition process that Bob wants to watch a piece of video on Alice's desktop via his iPhone. It is assumed that the URL of the video is “http://131.179.201.222/video1”. The URL can be transmitted via an email (email) or a short message. Bob clicks the “Get” button as shown in FIG. 5 on his own iPhone, and enters the URL of the video, and then the SMPA entity on Bob's iPhone adopts a modified URL (i.e., SID) to trigger a video application and the modified URL is “http://131.179.201.222/video1:iphone.bob@ucla.edu”, which connects the video's URL and the iPhone DID in series. Subsequently, the video application adopts the SID to request a service from a designated proxy (i.e., the SMPP entity). It should be noted that the video application just requests the service as usual. After the SMPP entity receives the request message transmitted by the SMPA entity on Bob's iPhone, the data plane of the SMPP entity extracts the actual URL from the SID carried in the request message, and makes a request for the video to Alice's desktop. Before the SMPP entity transmits the request to the SMPS entity, the data plane of the SMPP entity firstly creates a forwarding table entry, and the forwarding table entry includes a SID, and a DID and an address of Bob's iPhone. The forwarding table entry helps the data plane of the SMPP entity to notify the SMPS entity, so that the SMPS entity transmits a response to which device. If the request is successful, and the SMPS entity returns a responsive service description file, then the data plane of the SMPP entity creates forwarding table entries as shown in Table 1 in the forwarding table, and fills description information in the service description file, such as a port number. It is also necessary to modify the service description file, because the client information of the current service description file is of SMPP, such as an IP address and a port number of the client. When the information of the SMPP entity is modified to information of Bob's iPhone, the service description file will be transmitted to a video application of Bob's iPhone. Finally, the video application opens a desired port and waits for video data packets, and when Alice's desktop starts to transmit data packets, these data packets will be transited to Bob's iPhone based on the forwarding table in the data plane of the SMPP entity.

As shown in FIG. 9, Alice wants to share a piece of video with Bob. It is assumed that the URL of the video is “http://131.179.201.222/video1”, the piece of video is provided by a server on Alice's desktop (however, a source end of the video can be other service sources, such as YouTube, or can be shared via an SMP system, as long as Alice knows the URL of the video). Alice clicks a “Share” button for Bob in an address book on her desktop, and inputs the URL of the video, and then the SMPA entity of Alice's desktop transmits a VSR message to the SMPP entity, and the VSR message includes a DID of Alice's desktop, Bob's UID and the URL of the video. Subsequently, the control plane of the SMPP entity transmits an SRR message carrying the Bob's UID to the SMPS, so as to discover and locate a target device requested by the SMPA entity corresponding to Alice's desktop. Based on the global namespace shown in FIG. 3, the SMPS entity selects Bob's iPhone as a target device because he is out now, and returns a response message carrying a CoA of Bob's iPhone to the SMPP entity. Subsequently, the SMPP entity forwards the VSR message to the SMPA entity in Bob's iPhone, Bob's iPhone will pop up the VSR message inquiring Bob whether to allow the video shared by Alice to play on the iPhone. If Bob confirms the sharing, then the SMPA entity in the iPhone will start the service by triggering a video application. The later service startup process is just like the acquisition process.

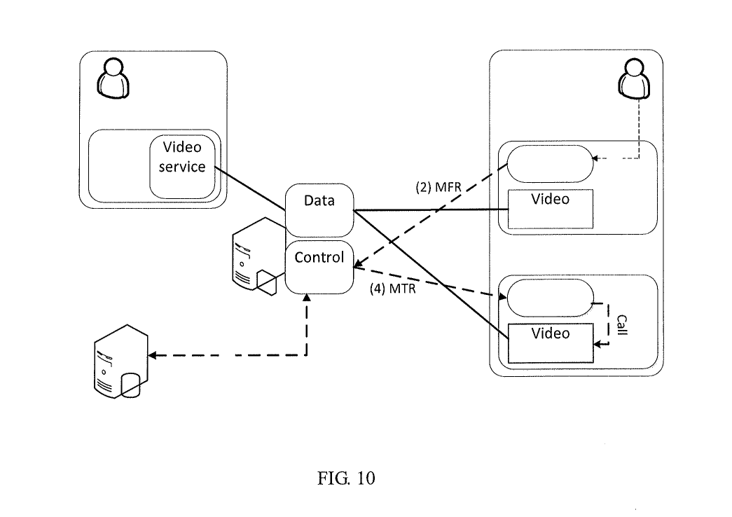

As shown in FIG. 10, Bob wants to migrate a service from his iPhone to his laptop. It is assumed that the migrated service is a video service, the URL thereof is “http://131.179.201.222/video1” as described above, once Bob clicks a “Migrate” button corresponding to his laptop, in the address book of the iPhone, and selects the URL of the video, then the SMPA entity on Bob's iPhone transmits an MFR message to the SMPP entity, and the MFR message carries the DID “laptop.bob@ucla.edu” and the SID “http://131.179.201.222/video1:iphone.bob@ucla.edu” of the target device. After the SMPP entity receives the MFR message, the control plane of the SMPP entity acquires a CoA of a laptop by transmitting an SRR message carrying the DID of the laptop to the SMPS entity. Then, the control plane of the SMPP entity notifies the laptop of receiving the service by transmitting an MTR message carrying the SID to the SMPA entity of the laptop. Meanwhile, the control plane of the SMPP entity updates the SID “http://131.179.201.222/video1:laptop.bob@ucla.edu” and the DID “laptop.bob@ucla.edu” of the laptop to the data plane, and the updating operation cannot be completed until the video application of the laptop connects to the SMPP entity. After the SMPA entity of the laptop receives the MTR, the SMPA entity adopts a temporary SID “http://131.179.201.222/video1:iphone.bob@ucla.edu:laptop.bob@ucla.edu” to initiate the video application to connect to the SMPP entity. The temporary SID includes the SID “http://131.179.201.222/video1:iphone.bob@ucla.edu” and the DID of the laptop, and therefore, the data plane of the SMPP entity can find corresponding entries and stored service description file. Then the data plane of the SMPP entity transmits the service description file to the video application on the laptop, and starts to monitor data packets of these entries. Once the moment for switching the service comes, the data plane of the SMPP entity switches to a new SID “http://131.179.201.222/video1:laptop.bob@ucla.edu” (formed by subtracting the DID of the iPhone from the temporary SID) and the DID and the address of the laptop in the forwarding table. The updated forwarding table entries are as shown in FIG. 2.

TABLE 2
Forwarding table entries in the SMPP entity after the service migrates from
an iPhone to a laptop.

| | | Server | | SMPP (Server) | |
|---|---|---|---|---|---|
| SID | DID | IP | Port | IP | Port |
| http://131.179.201.222/video1:laptop.bob@ucla.edu | laptop.bob@ucla.edu | 131.179.201.222 | 555 | 140.113.167.151 | 486 |
| http://131.179.201.222/video1:laptop.bob@ucla.edu | laptop.bob@ucla.edu | 131.179.201.222 | 555 | 140.113.167.151 | 487 |
| http://131.179.201.222/video1:laptop.bob@ucla.edu | laptop.bob@ucla.edu | 131.179.201.222 | 555 | 140.113.167.151 | 556 |
| http://131.179.201.222/video1:laptop.bob@ucla.edu | laptop.bob@ucla.edu | 131.179.201.222 | 555 | 140.113.167.151 | 557 |
| | | SMPP (Client) | | Client | |
| SID | DID | IP | Port | IP | Port |
| http://131.179.201.222/video1:laptop.bob@ucla.edu | laptop.bob@ucla.edu | 140.113.167.188 | 666 | 131.188.225.199 | 388 |
| http://131.179.201.222/video1:laptop.bob@ucla.edu | laptop.bob@ucla.edu | 140.113.167.188 | 666 | 131.188.225.199 | 389 |
| http://131.179.201.222/video1:laptop.bob@ucla.edu | laptop.bob@ucla.edu | 140.113.167.188 | 666 | 131.188.225.199 | 398 |
| http://131.179.201.222/video1:laptop.bob@ucla.edu | laptop.bob@ucla.edu | 140.113.167.188 | 666 | 131.188.225.199 | 399 |

How the TCP service migrates in the SMP architecture and the namespace will be further given below. FIG. 11 shows a flow chart of a TCP service migration. Bob requests to watch a piece of video from Alice's HTTP streaming server with an iPhone. When he gets back home, Bob wants to switch the video from the iPhone to his computer at home. the SMPA entity of Bob's iPhone will transmit an MFR message carrying a DID of Bob's computer and an SID of the migrated video, as long as Bob clicks the “Migrate” button in the address book of the iPhone. The SMPP entity is triggered by the MFR message and starts a suspending phase, and meanwhile the control plane of the SMPP entity acquires a CoA of the computer from the SMPS entity according to the DID of Bob's computer. Then, the control plane of the SMPP entity transmits an MTR message to the SMPA entity of Bob's computer, and the SID carried in the MTR message includes a URL of Alice's streaming server. The video application in Bob's compute is started to establish a link to the SMPP entity. After the SMPP entity receives a link request of Bob's computer, the SMPP entity enters a recovery phase immediately, and returns to a normal forwarding phase when the recovery phase ends, and meanwhile, the suspending phase also ends.

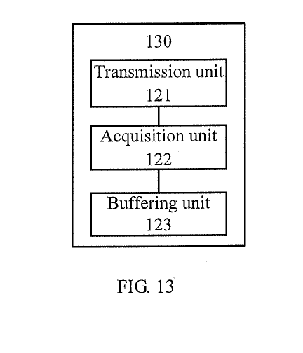

An apparatus for service migration between user devices according to an embodiment of the present invention is described in detail with reference to FIG. 12 and FIG. 13. The apparatus 120 for service migration between user devices includes a transmission unit 121 and an acquisition unit 122, particularly, the transmission unit 121 can be configured to receive a migration from request MFR transmitted by a service migration protocol application SMPA entity of a first device, where the MFR carries a device identity DID of a second device and a first service identity SID, and for requesting to migrate a service of the first device to the second device, the first service identity SID includes a service source uniform resource locator URL and a DID of the first device, and the first device and the second device belong to the first user. Optionally, the transmission unit 121 is configured to transmit a service migration protocol SMP resolution request SRR to a service migration protocol server SMPS entity, after knowing the DID of the second device from the MFR, where the SRR carries the device identity DID of the second device. Optionally, the transmission unit 121 is configured to receive a response message transmitted by the SMPS entity, where the response message carries a care-of address CoA of the second device resolved according to the device identity DID of the second device carried by the SRR. Optionally, the transmission unit 121 is configured to transmit a migration to request MTR to the SMPA entity of the second device according to the care-of address CoA of the second device, so that the second device initiates a service application, where the MTR carries the first service identity SID; where the care-of address CoA of the second device is a care-of address that is inquired and resolved by the SMPS entity from the global namespace and corresponding to the DID of the second device carried in the SRR. The acquisition unit 122 is configured to acquire the service on the service source device, after the second device initiates the service application and switches the first SID to the second SID, so as to migrate the service of the first device to the second device, where the second SID includes the service source uniform resource locator URL and the DID of the second device.

In addition, the transmission unit 121 is further configured to receive a service acquiring request transmitted by the SMPA entity of the first device, where the service acquiring request carries the first service identity SID and is used for requesting to acquire the service. Alternatively, the transmission unit 121 is configured to make a request for acquiring the service to the service source device according to the service source URL of the first SID.

Alternatively, the acquisition unit is further configured to acquire the service on the service source device, for providing to the first device.

Optionally, the transmission unit 121 is further configured to receive a sharing request SR transmitted by the SMPA entity of the service source device, where the SR carries the DID of the service source device, a user identity UID of the first user or a DID of the first device, and a service source URL. Alternatively, the transmission unit 121 is configured to transmit an SMP resolution request SRR to an SMPS entity, where the SRR carries the UID of the first user or the DID of the first device. Alternatively, the transmission unit 121 is configured to receive a response message transmitted by the SMPS entity, where the response message carries a care-of address CoA of the first device resolved according to the SRR. Alternatively, the transmission unit 121 is configured to transmit the sharing request SR to the SMPA entity of the first device, so that the first device initiates a service application; where the first device can be a preference device of the first user which is inquired and resolved by the SMPS entity from a global namespace and corresponding to the UID of the first user.

Optionally, the acquisition unit 122 is further configured to, after the first device initiates the service application, acquire the service on the service source device, for sharing to the first device.

Optionally, the transmission unit 121 is further configured to transmit a buffered data packet to the second device; and transmit an acknowledgment message ACK to the service source device.

In addition to the transmission unit 121 and the acquisition unit 122, the apparatus 130 for service migration between user devices can further include a buffering unit 123, as shown in FIG. 13. The buffering unit 123 is configured to buffer a payload data packet transmitted by the service source device, where a sequence number of the data packet is after a sequence number acknowledged in the last acknowledgment message ACK transmitted by the first device before the service migration is completed.

It can be seen from FIG. 4 that, the service migration protocol server SMPS entity includes a namespace management module and a resolution sever module, where the namespace management module manages synchronization of user registration and namespace and the resolution service module performs a resolution from an identify to an address and a resolution of a preference device of a user; the service migration protocol application SMPA entity includes a namespace synchronization module and a service migration protocol SMP service module, where the namespace synchronization module maintains a namespace group of a user, so as to collaborate with the namespace management module of the SMPS entity by using a function of namespace state synchronization, and the SMP service module is configured for triggering service acquisition, service sharing and service migration.

In view of the above, the apparatus for service migration between user devices in embodiments of the present invention enable each user to perform seamless migration between different devices of the user in different situations without interrupting the service reception, or even receive the service with a preference device of the user. In addition, the apparatus for service migration between user devices in embodiments of the present invention can complete the service migration without making any modification to the existing protocol and application in embodiments of the present invention.

Persons skilled in the art are aware that the various exemplary units and algorithm steps described in connection with the embodiments disclosed herein can be implemented as electronic hardware, or a combination of computer software and electronic hardware. Whether these functions are executed through hardware or software depends on special applications and design restrictions of the technical solutions. Professional technicians may implement the described functions in varying ways for each special application, but such implementation should not be considered as a departure from the scope of the present invention.

Persons skilled in the art can understand that, for convenience and brevity of description, with respect to the detailed working procedures of the systems, apparatuses, and units described above, corresponding procedures in the aforementioned method embodiments can be referred to, and are not repeated herein.

Understandably, in the embodiments described herein, the disclosed systems, apparatuses and methods may be implemented in other modes. For example, the device embodiments above are illustrative in nature, and the units of the device are defined from the perspective of logical functions only and may be defined in a different way in practical application. For example, multiple units or components may be combined or integrated into another system, or some features may be ignored or not executed. Besides, the coupling, direct coupling or communication connection between each other illustrated or discussed herein may be implemented through indirect coupling or communication connection between interfaces, devices or units, and may be electronic, mechanical, or in other forms.

The units described as stand-alone components above may be separated physically or not; and the components illustrated as units may be physical units or not, namely, they may be located in one place, or distributed on multiple network elements. Some or all of the units described above may be selected as required to fulfill the objectives of the technical solutions of the present invention.

Besides, all functional units in the embodiments of the present invention may be physically stand-alone, or integrated into a processing module, or two or more of the units are integrated into one unit.

When being implemented as a software function unit and sold or used as a stand-alone product, the functions may be stored in a computer-readable storage medium. Therefore, the essence of the technical solution of the present invention, or its contribution to the prior art, or part of the technical solutions, may be embodied in a software product. The computer software product may be stored in a computer-readable storage medium and incorporates several instructions for instructing a computer device (for example, personal computer, server, or network device) to execute all or part of the steps of the method specified in any embodiment of the present invention. Examples of the storage medium include various media capable of storing program codes, such as a USB flash disk, a mobile hard disk, a read-only memory (ROM, Read-Only Memory), a random access memory (RAM, Random Access Memory), a magnetic disk, or an optical disk.

The above descriptions are merely embodiments of the present invention, but not intended to limit the protection scope of the present invention. Any variations or replacement that can be easily derived by persons skilled in the art without departing from the technical scope disclosed by the present invention shall fall within the protection scope of the present invention. Therefore, the protection scope of the present invention is subject to the protection scope of the claims.

What is claimed is:

1. A method for service migration between user devices, comprising:
receiving a migration from request (MFR) transmitted by a service migration protocol application (SMPA) entity of a first device, wherein the MFR carries a device identity (DID) of a second device and a first service identity (SID) and is used for requesting to migrate a service of the first device to the second device, the first SID indicates a service stream between the first device and a service source device, and the first device and the second device belong to a first user;
transmitting a service migration protocol (SMP) resolution request (SRR) to a service migration protocol server (SMPS) entity, wherein the SRR carries the DID of the second device;
receiving a response message transmitted by the SMPS entity, wherein the response message carries a care-of address (CoA) of the second device resolved according to the device identity (DID) of the second device carried by the SRR;
transmitting, according to the CoA of the second device, a migration to request (MTR) to an SMPA entity of the second device, so that the second device initiates a service application and switches the first SID to a second SID, wherein the MTR carries the first SID; and
transmitting a service acquired from the service source device to the second device, so as to migrate the service of the first device to the second device, wherein the second SID indicates a service stream between the second device and the service source device.

2. The method according to claim 1, wherein the first SID comprises a service source uniform resource locator (URL) and a DID of the first device, and the second SID comprises the service source URL and the DID of the second device.

3. The method according to claim 1, wherein, before receiving the migration from request (MFR) transmitted by the service migration protocol application (SMPA) entity of the first device, further comprising: acquiring the service of the first device from the service source device in an acquiring mode or a sharing mode, wherein the service source device does not belong to the first user.

4. The method according to claim 3, wherein the acquiring the service of the first device from the service source device in the acquiring mode, comprises:
receiving a service acquiring request transmitted by the SMPA entity of the first device, wherein the service acquiring request carries the first SID and is used for requesting to acquire the service;
making a request for acquiring the service to the service source device according to the service source URL in the first SID; and
acquiring the service on the service source device, so as to provide to the first device.

5. The method according to claim 4, before making a request for acquiring the service to the service source device, further comprising: creating a forwarding table entry, wherein the forwarding table entry comprises the first SID and the DID and an address of the first device.

6. The method according to claim 3, wherein the acquiring the service of the first device from the service source device in the sharing mode, comprises:
receiving a sharing request (SR) transmitted by the SMPA entity of the service source device, wherein the SR carries a DID of the service source device, a user identity (UID) of the first user or the DID of the first device, and the service source URL;
transmitting an SMP resolution request (SRR) to an SMPS entity, wherein the SRR carries the UID of the first user or the DID of the first device;
receiving a response message transmitted by the SMPS entity, wherein the response message carries a care-of address (CoA) of the first device resolved according to the UID of the first user or the DID of the first device carried by the SRR;
transmitting the sharing request (SR) to the SMPA entity of the first device, so that the first device initiates a service application; and
acquiring the service on the service source device according to the DID of the service source device and the service source URL, so as to share to the first device.

7. The method according to claim 6, wherein, when the SR carries the user identity (UID) of the first user, the first device is a preference device of the first user, which is inquired and resolved by the SMPS entity from a global namespace and corresponding to the UID of the first user.

8. The method according to claim 1, wherein receiving, by the SMPP entity, the response message transmitted by the SMPS entity, wherein the response message carries the CoA of the second device resolved according to the SRR, comprises:
acquiring the CoA of the second device which is inquired and resolved by the SMPS entity from a global namespace corresponding to the DID of the second device carried in the SRR.

9. The method according to claim 1, wherein, when the service is a transmission control protocol TCP service, after receiving the migration from request (MFR) transmitted by the SMPA entity of the first device, the method further comprises: entering a suspending state until migration of the service is completed.

10. The method according to claim 9, wherein the entering the suspending state comprises:
transmitting an acknowledgment message (ACK) to the service source device, wherein the ACK carries information indicating that a receiving window is 0;
buffering a packet with payload transmitted by the service source device, wherein a sequence number of the packet is after a sequence number acknowledged in a last acknowledgment message (ACK) transmitted by the first device before the migration of the service is completed.

11. The method according to claim 9, wherein, after the second device initiates the service application and switches the first SID to the second SID, migrating the service of the first device to the second device, comprises:
after the second device initiates the service application and switches the first SID to the second SID, entering a recovery phase, and migrating the service of the first device to the second device;
wherein, the entering the recovery phase comprises:
after performing TCP handshake with the second device, transmitting the buffered packet to the second device;
after all the buffered packet has been transmitted, transmitting an acknowledgment message (ACK) to the service source device, wherein the ACK carries information indicating that a receiving window is not 0.

12. The method according to claim 1, wherein, the SMPS entity is configured to manage synchronization between user registration and namespace, and resolve mapping between an identify, and an address and a preference device of a user; the SMPA entity is configured to maintain a namespace group of a user, to use a namespace state synchronization function to collaborate with the SMPS entity, and trigger service acquisition, service sharing and service migration.

13. An apparatus for service migration between user devices, comprising a transmission unit and an acquisition unit; wherein:
the transmission unit is configured to receive a migration from request (MFR) transmitted by a service migration protocol application (SMPA) entity of a first device, wherein the MFR carries a device identity (DID) of a second device and a first service identity (SID), and is used for requesting to migrate a service of the first device to the second device, the first service identity (SID) indicates a service stream between the first device and a service source device, and the first device and the second device belong to a first user; transmit a service migration protocol (SMP) resolution request (SRR) to a service migration protocol server (SMPS) entity, after knowing the DID of the second device from the MFR, wherein the SRR carries the device identity (DID) of the second device; receive a response message transmitted by the SMPS entity, wherein the response message carries a care-of address (CoA) of the second device resolved according to the device identity (DID) of the second device carried by the SRR; transmit a migration to request (MTR) to an SMPA entity of the second device according to the care-of address (CoA) of the second device, so that the second device initiates a service application and switches the first SID to the second SID, wherein the MTR carries the first service identity (SID); wherein the care-of address (CoA) of the second device is a care-of address that is inquired and resolved by the SMPS entity from a global namespace and corresponding to the DID of the second device carried in the SRR;
the acquisition unit is configured to, after the second device initiates the service application and switches the first SID to the second SID, acquire a service on the service source device, to transmit the service acquired from the service source device to the second device, so as to migrate the service of the first device to the second device, wherein the second SID indicates a service stream between the second device and the service source device.

14. The apparatus according to claim 13, wherein the first SID comprises a service source uniform resource locator (URL) and a DID of the first device, and the second SID comprises the service source uniform resource locator URL and a DID of the second device.

15. The apparatus according to claim 13, wherein:
the transmission unit is further configured to receive a service acquiring request transmitted by the SMPA entity of the first device, wherein the service acquiring request carries the first service identity (SID) and is used for requesting to acquire the service; and
make a request for acquiring the service to the service source device according to the service source URL in the first SID;
the acquisition unit is further configured to acquire the service on the service source device, so as to provide to the first device.

16. The apparatus according to any one of claim 13, wherein:
the transmission unit is further configured to receive a sharing request (SR) transmitted by the SMPA entity of the service source device, wherein the SR carries a DID of the service source device, a user identity (UID) of the first user or a DID of the first device, and a service source URL; transmit an SMP resolution request (SRR) to an SMPS entity, after knowing from the SR the user identity (UID) of the first user or the DID of the first device, wherein the SRR carries the UID of the first user or the DID of the first device; receive a response message transmitted by the SMPS entity, wherein the response message carries a care-of address (CoA) of the first device resolved according to the UID of the first user or the DID of the first device carried by the SRR; transmit the sharing request (SR) to the SMPA entity of the first device, so that the first device initiates a service application; wherein the first device is a preference device of the first user that is inquired and resolved by the SMPS entity from a global namespace and is corresponding to the UID of the first user.
the acquisition unit is further configured to, after the first device initiates the service application, acquire the service on the service source device according to the DID of the service source device and the service source URL, for sharing to the first device.

17. The apparatus according to claim 13, wherein the global namespace defines mapping between the user identity (UID) and the device identity (DID), and mapping between the device identity (DID) and the care-of address (CoA).

18. The apparatus according to a claim 13, further comprising a buffering unit, configured to buffer a packet with payload transmitted by the service source device, wherein a sequence number of the packet is after a sequence number acknowledged in the last acknowledgment message (ACK) transmitted by the first device before the service migration is completed.

19. The apparatus according to claim 13, wherein the transmission unit is further configured to:
transmit the buffered packet to the second device, and transmit an acknowledgment message (ACK) to the service source device.

20. The apparatus according to claim 13, wherein:
the service migration protocol server (SMPS) entity comprises a namespace management module and a resolution service module, wherein the namespace management module manages synchronization between user registration and namespace and the resolution service module makes resolution from an identify to an address and resolution of a preference device of a user;
the service migration protocol application (SMPA) entity comprises a namespace synchronization module and a service migration protocol (SMP) service module, wherein the namespace synchronization module maintains a namespace group of a user, so as to use a namespace state synchronization function to collaborate with the namespace management module of the SMPS entity by means of, and the SMP service module is configured to trigger service acquisition, service sharing and service migration.
